(19) United States
(12) Patent Application Publication
(10) Pub. No.: US 2019/0006875 A1
(43) Pub. Date: Jan. 3, 2019

(54) Door Lock Charging System and Door Lock Apparatus

(71) Applicants: ULSAN NATIONAL INSTITUTE OF SCIENCE AND TECHNOLOGY (UNIST), Ulsan (KR); ZN TECHNOLOGIES CO., LTD., Ulsan (KR)

(72) Inventors: Franklin Don Bien, Ulsan (KR); Saikiran Oruganti, Ulsan (KR); Jagannath Malik, Ulsan (KR); Woojin Park, Ulsan (KR); Bonyoung Lee, Ulsan (KR); Nakyoung Ko, Ulsan (KR); Seongkyu Song, Ulsan (KR); Seoktae Seo, Ulsan (KR); Chang Soo Kang, Yongin (KR); Chul Gyun Park, Seoul (KR)

(21) Appl. No.: 15/967,175

(22) Filed: Apr. 30, 2018

(30) Foreign Application Priority Data
Jun. 29, 2017 (KR) 10-2017-0082909

(51) Int. Cl. H02J 7/02; H02J 7/00; H02J 50/20; E05B 47/00

(52) U.S. Cl. CPC H02J 7/025; H02J 7/0042; E05B 2047/0061; E05B 47/00; E05B 2047/0058; H02J 50/20

(57) ABSTRACT

Disclosed is a door lock charging apparatus for receiving power from an external power supply and generating an electromagnetic field for charging a door lock apparatus, the door lock charging apparatus including an electromagnetic field generator electrically connected to a power supply and configured to generate an electromagnetic field on the conductive surface using the power supply and a charger configured to propagate the generated electromagnetic field to a door lock apparatus attached to a second position on the conductive surface.

### CROSS-REFERENCE TO RELATED APPLICATIONS

This application claims the priority benefit of Korean Patent Application No. 10-2017-0082909 filed on Jun. 29, 2017, in the Korean Intellectual Property Office, the disclosure of which is incorporated herein by reference for all purposes.

### BACKGROUND

1. Field

One or more example embodiments relate to a door lock charging system and a door lock apparatus and, more particularly, to a door lock charging system and a door lock apparatus for wirelessly charging and transmitting power through a conductive surface.

2. Description of Related Art

Door lock devices are used for access control at home or offices. Specifically, an electric door lock system using a biosignal-based user authentication technique as well as door lock systems of a password type, a memory integrated circuit (IC) electronic key type, and a radio frequency (RF) type such as a transportation card is widely used.

The door lock devices may use a battery for power supply. When a predetermined time elapses, the battery may need to be replaced. When the battery is not replaced in advance, a user may experience an inconvenience of locking and unlocking a door. Accordingly, there is an increasing interest in a technique for realizing a semi-permanent door lock device that constantly charges power based on wireless power technology without need to replace the battery.

### SUMMARY

According to an aspect, there is provided a door lock charging apparatus for receiving power from an external power supply and generating an electromagnetic field for charging a door lock apparatus, the door lock charging apparatus including an electromagnetic field generator electrically connected to a power supply and configured to generate an electromagnetic field on the conductive surface using the power supply and a charger configured to propagate the generated electromagnetic field to a door lock apparatus attached to a second position on the conductive surface.

The electromagnetic field generator may be formed of a conductive material, includes at least one opening, and is configured to vertically propagate an electric field on the conductive surface.

The electromagnetic field generator may include a first layer including the at least one opening, and the charger may include a second layer formed of a conductive material and configured to contact the conductive surface and a third layer formed of a dielectric material and disposed between the first layer and the second layer to induce an electromagnetic field to the third layer based on the electric field.

The charger may be configured to propagate the electric field through the second layer to induce an electromagnetic field in which a magnetic field is dominant to the conductive surface.

The second layer may include a 3×3 array of nine openings.

At least one of the first layer and the second layer may include a copper material. The third layer may include at least one of a carbon fiber material, an acrylic material, and a polycarbonate material.

According to another aspect, there is also provided a door lock apparatus that receives power through a conductive surface of a door, the apparatus including a charger attached to a first position on the conductive surface and configured to generate an energy using an electromagnetic field propagated by a door lock charging apparatus attached to a second position on the conductive surface and a battery configured to store the energy and provide a power used by the door lock apparatus to lock and unlock the door.

The charger may include a first layer formed of a conductive material and including at least one opening that faces the conductive surface, a second layer formed of a conductive material and disposed adjacent to the first layer, and a third layer formed of a dielectric material and disposed between the first layer and the second layer to receive an electromagnetic field propagated from the conductive surface.

The third layer may be configured to receive a first electromagnetic field induced to the conductive surface through the at least one opening, and a second electromagnetic field may be induced based on the first electromagnetic field. In the dielectric material of the third layer, the second electromagnetic field in which an electric field is dominant may be induced from the first electromagnetic field in which a magnetic field is dominant.

At least one of the first layer and the second layer may include a copper material. The third layer may include at least one of a carbon fiber material, an acrylic material, and a polycarbonate material.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an operation of a door lock charging apparatus and a door lock apparatus according to an example embodiment;

FIG. 2 is a diagram illustrating a process of power transmission and reception performed by the door lock charging apparatus and the door lock apparatus of FIG. 1;

FIG. 3 is a diagram illustrating an example of a door lock charging apparatus according to an example embodiment;

FIG. 4 is a top view of the door lock charging apparatus of FIG. 3;

FIG. 5 is a side view illustrating a door lock charging apparatus according to an example embodiment; and

FIG. 6 is a block diagram illustrating a door lock charging apparatus and a door lock apparatus according to an example embodiment.

### DETAILED DESCRIPTION

Hereinafter, some example embodiments will be described in detail with reference to the accompanying drawings.

It should be understood, however, that there is no intent to limit this disclosure to the particular example embodiments disclosed. On the contrary, example embodiments are to cover all modifications, equivalents, and alternatives falling within the scope of the example embodiments.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

### Summary of a Door Lock Charging Apparatus and a Door Lock Apparatus

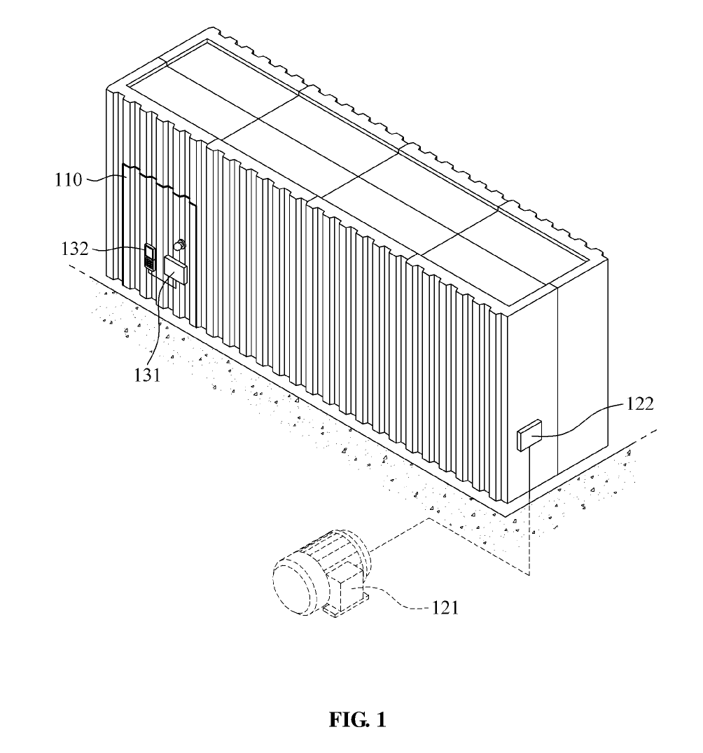

FIG. 1 is a diagram illustrating an operation of a door lock charging apparatus and a door lock apparatus according to an example embodiment. FIG. 1 illustrates a door 110 including a conductive surface, a power supply 121, a door lock charging apparatus 122, a wireless power receiving apparatus 131, and a door lock apparatus 132. For example, the power supply 121 may be disposed external to the door lock charging apparatus 122. The door lock charging apparatus 122 may include a wireless power transmitting apparatus having a structure corresponding to the wireless power receiving apparatus 131. Although FIG. 1 illustrates that the wireless power receiving apparatus 131 and the door lock apparatus 132 are provided separately, the door lock apparatus 132 may include the wireless power receiving apparatus 131 depending on an example.

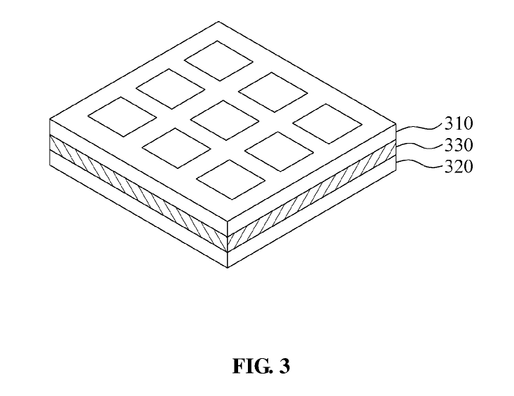

The door lock charging apparatus 122 and the wireless power receiving apparatus 131 may be attached to the door 110 having the conductive surface. Also, the door lock charging apparatus 122 may form an electromagnetic field on the conductive surface and transmit power to the wireless power receiving apparatus 131 using the electromagnetic field. Structures of the door lock charging apparatus 122 and the wireless power receiving apparatus 131 will be also described with reference to FIGS. 3 through 5.

The door lock charging apparatus 122 may receive power from the power supply 121. In one example, the power supply 121 may be implemented as, for example, a rechargeable battery such as a lithium ion battery. In another example, the power supply 121 may be implemented as a power supplier corresponding to power specifications required for the door lock apparatus 132. The door lock charging apparatus 122 may receive a prevailing voltage, for example but not limited to, an alternating current (AC) of 200 volts (V) from the power supply 121.

The door lock charging apparatus 122 may transfer power to the wireless power receiving apparatus 131 using the power received from the power supply 121. The door lock charging apparatus 122 may transmit wireless power to the wireless power receiving apparatus 131 through the conductive surface included in the door 110. The door lock charging apparatus 122 may generate an electromagnetic field using the received power. Also, the door lock charging apparatus 122 may propagate the generated electromagnetic field to the conductive surface such that the power is transferred to the wireless power receiving apparatus 131.

As illustrated in FIG. 1, the door lock charging apparatus 122 and the wireless power receiving apparatus 131 may be separately disposed at different positions on a single conductive surface. Also, although FIG. 1 illustrates the door lock charging apparatus 122 and the wireless power receiving apparatus 131 are disposed on a single surface as an example, the present example is not to be taken as being limited thereto. For example, the door lock charging apparatus 122 may be disposed on a front side of the conductive surface and the wireless power receiving apparatus 131 may be disposed on a rear side of the conductive surface.

### Principle of Wireless Power Transmission and Reception

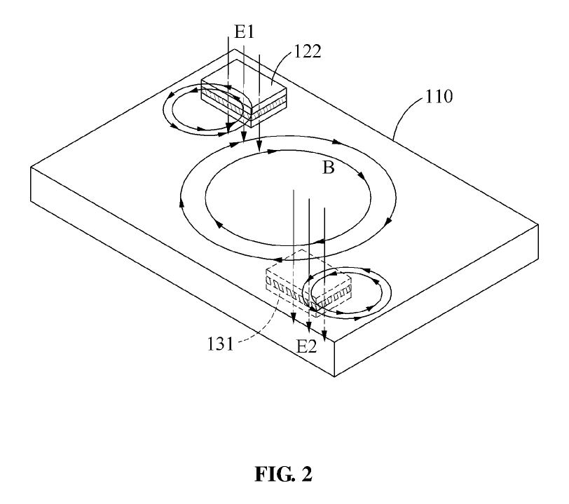

FIG. 2 is a diagram illustrating a process of power transmission and reception performed by the door lock charging apparatus and the door lock apparatus of FIG. 1. FIG. 2 illustrates a process of power transmission and reception performed by the door lock charging apparatus 122 and the wireless power receiving apparatus 131 through the conductive surface included in the door 110. As described above, the door lock apparatus 132 may include the wireless power receiving apparatus 131 depending on an example. The conductive surface included in the door 110 may be, for example, a steel plate or a frame structure of the door 110. Hereinafter, a power transmission and reception method will be described based on an example in which the conductive surface includes a magnetic material and an example in which the conductive surface includes a diamagnetic material.

### Example of Conductive Surface Including Magnetic Material

Conductive layers included in the door lock charging apparatus 122 may form an electromagnetic field on a dielectric layer. Based on the electromagnetic field, an electromagnetic field in which a magnetic field is dominant may be generated on the conductive surface. An electric field E1 of the generated electromagnetic field may be vertically propagated on the conductive surface through an aperture of the door lock charging apparatus 122. The door lock charging apparatus 122 may generate the electric field E1 using a voltage received from an external power supply. Also, the door lock charging apparatus 122 may vertically propagate the electric field E1 on the conductive surface through the aperture therein. The propagated electric field E1 may be used to generate an electromagnetic field B in which a magnetic field is dominant on the conductive surface.

In this example, based on a structure and a principle of a theory of reversible, the wireless power receiving apparatus 131 may accept energy from the electromagnetic field formed on the conductive surface. In response to a change in the electromagnetic field B in which the magnetic field is dominant on the conductive surface, an electromagnetic field E2 in which an electric field is dominant may be transferred to a dielectric layer in the wireless power receiving apparatus 131. The electromagnetic field E2 may be transferred to the dielectric layer through the aperture included in the wireless power receiving apparatus 131.

As such, since the magnetic field is dominant in power transmission and reception using a magnetic material, a change in impedance may be relatively small even when a shape and a size of the conductive surface of the door 110 are changed. Also, the conductive surface may have power transmission efficiency higher than that of an air-based propagation system because a magnetic permeability of the conductive surface is greater than air.

For example, a magnetic permeability of steel may be about 2000 and a magnetic permeability of pure iron may be about 4000 to 5000, which may be a value about 2000 times greater than a magnetic permeability of air and a value about 4000 to 5000 times greater than the magnetic permeability of air, respectively. Thus, in comparison to propagation in the air, the magnetic field may be propagated in the magnetic material at a higher magnitude in a longer distance. To form the electromagnetic field in which the magnetic field is dominant, a resonator and a circuit may be designed such that a predetermined magnitude of magnetic field is formed in a metal body in the resonator and the circuit.

When the conductive surface is a metal medium having a relatively high magnetic permeability, propagation efficiency may increase and a transmission distance may vary based on a wavelength size of an operating frequency. Also, it may be possible to transmit energy to a resonator located in a predetermined distance from the metal medium using the electromagnetic field formed on the conductive surface. Since the magnetic field is dominant in the formed electromagnetic field, an electric field may be emitted from the conductive surface. In this instance, when an antenna resonated at the operating frequency is located in the predetermined distance on the conductive surface, energy reception may be performed.

A dielectric material of the dielectric layer included in the wireless power receiving apparatus 131 and the door lock charging apparatus 122 may reduce a thickness and a size of the resonator. Also, the dielectric material may form the electromagnetic field B in which the magnetic field is dominant such that a sufficient amount of energy is transmitted.

### Example of Conductive Surface Including Paramagnetic Material or Diamagnetic Material

The door lock charging apparatus 122 may control a current to flow on the conductive layer using a transmitted power. The current may be used to form the electromagnetic field E1 in which the electric field is dominant on the conductive surface included in the door 110.

In this example, an electric field propagated through the aperture may not form the electromagnetic field B on the conductive surface. When the conductive surface includes a paramagnetic material or a diamagnetic material, the magnetic permeability of the conductive surface may be similar to that of the air. Thus, in contrast to a conductive surface including a ferromagnetic material, the magnetic field may be transferred at a magnitude similar to or less than that of the air on the conductive surface including the paramagnetic material or the diamagnetic material. Also, the magnetic field may be transferred in a similar propagation distance on the conductive surface of the door 110 and in the air.

The magnetic permeability of pure iron that is a ferromagnetic material may be in a range from 4000 to 5000. In contrast, a magnetic permeability of aluminum that is paramagnetic material and a magnetic permeability of silver that is the diamagnetic material may be about 1.0. In cases in which conductive surfaces respectively include the pure iron, the aluminum, and the silver, the magnetic field may be propagated at difference magnitudes on the conductive surface of the door 110. When the conductive surface includes the paramagnetic material or the diamagnetic material, a signal may be propagated to the wireless power receiving apparatus 131 by a current induced from a layer in contact with the conductive surface among conductive layers of the door lock charging apparatus 122. In this example, an electric field emitted from the aperture of the door lock charging apparatus 122 may be induced to the conductive surface of the door 110 such that power transmission is performed based on the electric field.

### Structure of Wireless Power Transmitting and Receiving Apparatus

FIG. 3 is a diagram illustrating an example of a door lock charging apparatus according to an example embodiment. A door lock charging apparatus may be attached to a first position on a conductive surface included in a door to transmit power to a door lock apparatus attached to a second position on the conductive surface. The door lock apparatus may include a wireless power reception apparatus as described above.

Referring to FIG. 3, the door lock charging apparatus may include an electromagnetic field generator 310 that is electrically connected to a power supply and configured to generate an electromagnetic field using power transferred through the power supply. The electromagnetic field generator 310 may also be referred to as, for example, a first layer 310. Although not shown, the electromagnetic field generator 310 may be electrically connected to an external power supply. The electromagnetic field generator 310 may generate the electromagnetic field on the conductive surface using the power transferred from the power supply. The electromagnetic field generator 310 may include a conductive material and at least one opening. The electromagnetic field generator 310 may be implemented as a first layer including at least one opening. The electromagnetic field generator 310 may vertically propagate an electric field on the conductive surface through the at least one opening.

Chargers 320 and 330 may propagate the generated electromagnetic field to the door lock apparatus attached to the second position on the conductive surface. The chargers 320 and 330 may also be referred to as, for example, a second layer 320 and a third layer 330. The chargers 320 and 330 may include the second layer 320 including a conductive material and contacting the conductive surface. Also, the chargers 230 and 330 may include the third layer 330 including a dielectric material and disposed between the first layer 310 corresponding to the electromagnetic field generator 310 and the second layer 320 such that an electromagnetic field is induced based on the electric field. The chargers 320 and 330 may propagate the electric field through the second layer 320 to induce an electromagnetic field in which a magnetic field is dominant on the conductive surface. The second layer 320 may include, for example but not limited to, a 3×3 array of nine openings. Also, at least one of the first layer 310 and the second layer 320 may include a copper material. The third layer 330 may include at least one of a carbon fiber material, an acrylic material, and a polycarbonate material.

Thicknesses of the first layer 310, the second layer 320, and the third layer 330 may be determined to form an electromagnetic field in which a magnetic field is dominant on the conductive surface based on a skin depth and a wavelength of the electromagnetic field such that a sufficient amount of energy is transferred. Dissimilarly to the example of FIG. 3, an additional layer having a different electric property may be added to the first layer 310 in a direction opposite to the third layer 330. In one example, a dielectric layer may be added upward the first layer 310, that is, a direction opposite to the conductive surface as a fourth layer to induce a strong electromagnetic field to be formed. In another example, a nonconductive layer may be added upward the first layer 310 to prevent an electric connection to the conductive surface. When the nonconductive layer is added, a wireless power transmission and reception apparatus may be prevented from being shorted from the conductive surface, which may lead to degradation in power transmission efficiency.

The third layer 330 may include a dielectric material or a nonconductive material. For example, the third layer 330 may include at least one of a carbon fiber material, an acrylic material, and a polycarbonate material but not limited thereto. In addition, the third layer 330 may include another material, for example, paint and a polymer resin film. Also, the third layer 330 may include multiple layers having different properties, for example, a plurality of dielectric materials and nonconductive materials.

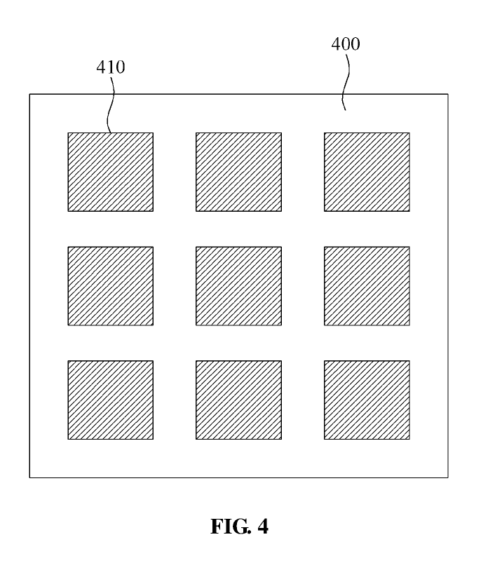

FIG. 4 is a top view of the door lock charging apparatus of FIG. 3. FIG. 4 illustrates a charger 400 of the door lock charging apparatus. The charger 400 may include a first layer including, for example but not limited to, a 3×3 array of nine openings 410. The example described with reference to FIG. 4 is only an exemplary description for facilitating understanding of the invention, and should not be construed as limiting the scope of the scope of the example embodiments. A number of openings may vary based on a material or a thickness of a conductive surface on which power transmission and reception is performed. The first layer of the charger 400 may have one or more openings and may also not have an opening.

Although FIG. 4 illustrates the opening 410 in a quadrangular shape as an example, the opening 410 may also be provided in various shapes, for example, a circular shape or a polygonal shape. A size of the opening 410 may be determined to form an electromagnetic field in which a magnetic field is dominant based on a material of the conductive surface such that a sufficient amount of energy is transmitted.

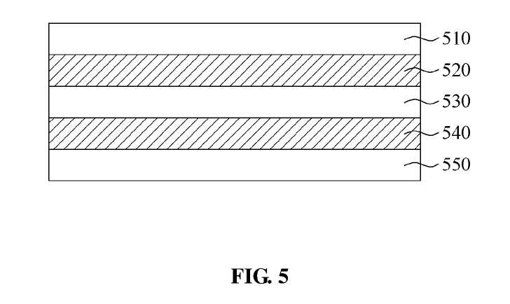

FIG. 5 is a side view illustrating a door lock charging apparatus according to an example embodiment. Referring to FIG. 5, a dielectric layer 520 may be disposed between conductive layers 510 and 530 and a dielectric layer 540 may be disposed between the conductive layer 530 and a conductive layer 550. The conductive layers 510, 530, and 550 may include, for example, a copper material. A number of dielectric layers disposed between conductive layers and thicknesses of the dielectric layers may vary based on power specifications and a material of a conductive surface. For example, the number of dielectric layers and the thicknesses of the dielectric layers may be determined for transmitting an amount of energy sufficient to form an electromagnetic field in which a magnetic field is dominant on the conductive surface.

Although the foregoing examples are described based on the door lock charging apparatus having a waveguide structure, various types of door lock charging apparatuses, for example, a patch-type door lock charging apparatus and a horn-type door lock charging apparatus are applicable when a resonator is designed to have a structure for forming an electromagnetic field in which a magnetic field is dominant to perform power transmission and reception on a conductive surface.

### Example of Additional Magnetic Induction

In one example, a ferromagnetic material may be added to a conductive surface included in a door to induce a strong magnetic field in the conductive surface. A dielectric layer or a nonconductive layer may be attached to an upper end of a layer contacting the conductive surface and the ferromagnetic material may be attached to an upper end of the dielectric layer or the nonconductive layer. The ferromagnetic material may form a strong magnetic field. In this example, a magnetic field may be induced on the conductive surface at a higher intensity in comparison to a case in which the magnetic field is induced directly. When the ferromagnetic material corresponds to a refined iron or a Mu-metal having a magnetic permeability ranging between 100000 and 200000, much stronger magnetic field may be formed on the conductive surface. In another example, it is also possible to wind a coil around the ferromagnetic material and attach the ferromagnetic material to the conductive surface of the door while forming the magnetic field on the ferromagnetic material.

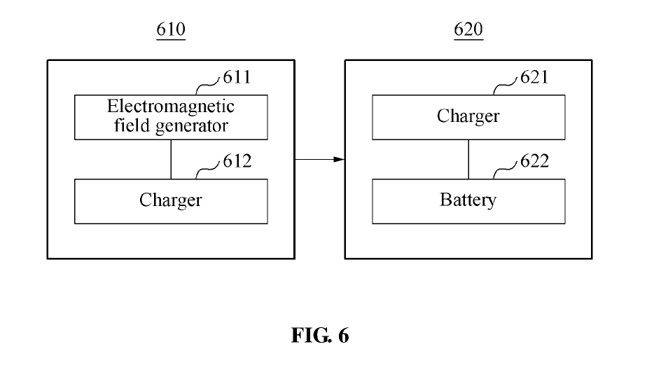

FIG. 6 is a block diagram illustrating a door lock charging apparatus and a door lock apparatus according to an example embodiment. Referring to FIG. 6, a door lock charging apparatus 610 may charge a door lock apparatus 620 using power transmitted from an external power supply. The door lock charging apparatus 610 may include an electromagnetic field generator 611 and a charger 612. The door lock charging apparatus 610 may be attached to a first position on a conductive surface of a door. The electromagnetic field generator 611 may be electrically connected to a power supply and generate an electromagnetic field on the conductive surface using the power supply. The charger 612 may propagate the generated electromagnetic field to the door lock apparatus 620 attached to the second position on the conductive surface. Since the description of FIGS. 3 through 5 is also applicable to the electromagnetic field generator 611 and the charger 612, repeated description will be omitted for brevity.

The door lock apparatus 620 may receive wireless power at the second position of the conductive surface from the door lock charging apparatus 610. A charger 621 may be attached to the second position of the conductive surface and generate energy using the electromagnetic field propagated by the door lock charging apparatus 610 attached to the first position. A battery 622 may store the energy and provide power to be used by the door lock apparatus 620 to lock and unlock the door.

The charger 621 may include a first layer, a second layer, and a third layer. The first layer may be formed on a conductive material and include at least one opening that faces the conductive surface. The second layer may be formed of a conductive material and disposed adjacent to the first layer. The third layer may be formed of a dielectric material and disposed between the first layer and the second layer to receive the electromagnetic field propagated from the conductive surface. The third layer may receive a first electromagnetic field induced to the conductive surface through the at least one opening. The first electromagnetic field may be used to induce a second electromagnetic field. Also, the second electromagnetic field in which an electric field is dominant may be induced from the first electromagnetic field in which a magnetic field is dominant in the dielectric material of the third layer. At least one of the first layer and the second layer may include a copper material. The third layer may include at least one of a carbon fiber material, an acrylic material, and a polycarbonate material.

The door lock charging apparatus 610 may convert a direct current (DC) output from a power output into an analog or radio frequency (RF) signal and transmit the analog or RF signal using the charger 612 based on an electromagnetic field. Similarly, the charger 621 included in the door lock apparatus 620 may receive an emitted analog or RF signal and convert the received analog or RF signal into a DC in a receiving circuit to supply power required for the battery 622. Although not shown, the charger 621 may use a converting circuit to perform conversion, for example, a DC-to-DC conversion, on a received power at a voltage required for the door lock apparatus 620 and supply the converted power.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A door lock charging apparatus attached to a first position on a conductive surface, the apparatus comprising:
an electromagnetic field generator electrically connected to a power supply and configured to generate an electromagnetic field on the conductive surface using the power supply; and
a charger configured to propagate the generated electromagnetic field to a door lock apparatus attached to a second position on the conductive surface.

2. The door lock charging apparatus of claim 1, wherein the electromagnetic field generator is formed of a conductive material, includes at least one opening, and is configured to vertically propagate an electric field on the conductive surface.

3. The door lock charging apparatus of claim 2, wherein the electromagnetic field generator comprises a first layer including the at least one opening, and
the charger comprises:
a second layer formed of a conductive material and configured to contact the conductive surface; and
a third layer formed of a dielectric material and disposed between the first layer and the second layer to induce an electromagnetic field to the third layer based on the electric field.

4. The door lock charging apparatus of claim 3, wherein the charger is configured to propagate the electric field through the second layer to induce an electromagnetic field in which a magnetic field is dominant to the conductive surface.

5. The door lock charging apparatus of claim 2, wherein the second layer includes a 3×3 array of nine openings.

6. The door lock charging apparatus of claim 1, wherein at least one of the first layer and the second layer includes a copper material.

7. The door lock charging apparatus of claim 1, wherein the third layer includes at least one of a carbon fiber material, an acrylic material, and a polycarbonate material.

8. A door lock apparatus that receives power, the apparatus comprising:
a charger attached to a first position on a conductive surface and configured to generate an energy using an electromagnetic field propagated by a door lock charging apparatus attached to a second position on the conductive surface; and
a battery configured to store the energy and provide a power used by the door lock apparatus to lock and unlock a door.

9. The door lock apparatus of claim 8, wherein the charger comprises:
a first layer formed of a conductive material and including at least one opening that faces the conductive surface;
a second layer formed of a conductive material and disposed adjacent to the first layer; and
a third layer formed of a dielectric material and disposed between the first layer and the second layer to receive an electromagnetic field propagated from the conductive surface.

10. The door lock apparatus of claim 9, wherein the third layer is configured to receive a first electromagnetic field induced to the conductive surface through the at least one opening, and a second electromagnetic field is induced based on the first electromagnetic field.

11. The door lock apparatus of claim 10, wherein, in the dielectric material of the third layer, the second electromagnetic field in which an electric field is dominant is induced from the first electromagnetic field in which a magnetic field is dominant.

12. The door lock apparatus of claim 9, wherein at least one of the first layer and the second layer includes a copper material.

13. The door lock apparatus of claim 9, wherein the third layer includes at least one of a carbon fiber material, an acrylic material, and a polycarbonate material.
